(19) United States
(12) Patent Application Publication
(10) Pub. No.: US 2006/0107696 A1
(43) Pub. Date: May 25, 2006

(54) Method for producing polarizing glass

(75) Inventor: Yuichi Aoki, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Joetsu-shi (JP)

(21) Appl. No.: 11/232,161

(22) Filed: Sep. 21, 2005

Related U.S. Application Data
(63) Continuation of application No. PCT/JP04/09909, filed on Jul. 6, 2004.

(30) Foreign Application Priority Data
Jul. 31, 2003 (JP) 2003-204766

(51) Int. Cl. C03B 23/037; C03B 32/00; C03C 15/00; C03C 19/00

(52) U.S. Cl. 65/30.1; 65/31; 65/32.3; 65/32.5; 65/104; 65/117

(57) ABSTRACT

A method for producing a polarizing glass wherein a glass preform containing metal halide particles having a prescribed particle size dispersed therein is heated to a prescribed temperature and elongated, to thereby form a glass sheet containing elongated metal halide particles, and then said metal halide particles are reduced to the metal, characterized in that the glass sheet having been heated and elongated is quenched and then subjected to an annealing treatment, and thereafter, the above metal halide particles are reduced to the metal. The method allows the removal of the stress which generates during the above heating and elongating treatment and residues in the glass sheet, without the reduction of the extinction ratio of the resultant glass sheet, which results in the production of a polarizing glass having good optical characteristics at a low cost.

The present patent application is a continuation application of PCT/JP2004/009909 filed on Jul. 6, 2004 which claims priority from a Japanese patent application No. 2003-204766 filed on Jul. 31, 2003, the contents of which are incorporated herein by reference.

### BACKGROUND OF THE INVENTION

1. Field of the Invention

The present invention relates to a method for producing a polarizing glass.

2. Description of the Related Art

Polarizing glass is used for optical communication in the near-infrared range, and, in particular, as an optical isolator of a polarized wave dependent type.

Reliability is especially important in the optical communication field, and accordingly polarizing glass used in this field is expected to have high level heat resistance, environmental resistance, and optical characteristics. In particular, it is required at a minimum as the optical characteristics that an insertion loss is equal to or less than 0.1 dB and an extinction ratio is equal to or larger than 40 dB.

Since the polarizing glass has these kinds of good properties, accompanied by practical use of blue laser diode, it is expected to be applied to a field such as a high density optical recording apparatus, an LCD projector, etc. which conventionally use a polarizing film and a wire grid polarizer.

However, cost is a very important factor as the field is for consumer use. Thus, a technique for producing the polarizing glass at a low cost by improving the producing yield is required in addition to an improvement of properties.

The polarizing glass is made by a process of melting abase glass material containing halide, a heat treatment process of precipitating metal halide particles in the base glass material, a elongating process of elongating metal halide particle, a polishing process, and a reducing process of conducting a reducing treatment of the metal halide particles.

Among the processes, the elongating process is a process of applying stress on a glass preform to stretch metal halide particles contained in the glass preform and making the glass perform a glass sheet. When the glass is elongated, viscosity of the glass is substantially 1×10⁸ poises and the stress is 200 Kg/cm² to 600 Kg/cm². Thus, there is a problem that the glass is easy to be broken and damaged.

Accordingly, Japanese Patent Application Laid Open No. 1990-40619, Japanese Patent Nos. 3105491 and 3320044, etc. disclose methods for preventing the glass preform from being broken and damaged.

However, experiments by the inventor of the present invention made it clear that there is another problem in the elongating process in addition to the breakage and damage of the glass preform. Even in case the elongating is performed without being broken and damaged, there is a problem that crack occurs in the longwise direction if the glass is left as it is and the glass is cracked to be torn.

This is because viscosity of the glass is substantially 1×10⁸ poises during the elongating process as described above and the viscosity is almost the lowest limit of working viscosity range during hot processing.

In other words, it was clarified that the breakage and damage of the glass occurs because the stress of 200 Kg/cm² to 600 Kg/cm² is applied on the glass preform of which viscosity is almost the lowest limit of working viscosity. Further, crack occurs during the polishing process following the elongating process and the glass is broken into pieces even if the elongating is performed without breakage and damage.

If the surface treatment of the glass preform is carried out, it is possible to prevent the breakage and damage during the elongating process. However, there is no recognition in the above conventional method about the glass sheet obtained after stretch.

The inventors of the present invention made the followings clear by observing and performing a testing on the elongating process.

In case the glass is subject to a rapid cooling right after being drawn from a heating furnace (a glass elongating furnace), the glass sheet is cracked to be torn and, in case the glass is not subject to a rapid cooling rapidly contrarily, the case where the glass sheet is cracked is rare.

Further, according to examination of the glass sheet using a strain measurement and the like, tensile strain residues in the glass sheet and there is a large strain especially on an end in the lengthwise direction (the width direction).

From the above, they come to the conclusion that a cause of the crack generated in the lengthwise direction is the residue strain in the glass sheet.

In order to prevent the crack of the glass sheet from generating, it is preferable not to cool rapidly the glass sheet. However, if the glass sheet is not cooled rapidly, the elongated metal halide particles are restored to spherical shape and the extinction ratio which is one of important optical characteristics decreases.

The inventor conducted various kinds of experiments on the basis of the above understanding and thus completed the present invention which can eliminate the strain of the glass sheet without causing decrease of the extinction ratio.

### SUMMARY OF THE INVENTION

Therefore, it is an object of the present invention to provide a polarizing glass of good optical characteristics at a low cost by eliminating strain, which is generated during heating and elongating processes and residues in a glass sheet, without causing decrease of the extinction ratio.

The present invention relates to a method for producing a polarizing glass having a prescribed polarization characteristic by heating to a prescribed temperature and elongating a glass preform containing metal halide particles having a prescribed particle size dispersed therein to form a glass sheet containing the elongated metal halide particles and then reducing the metal halide particles to make metal, wherein an annealing treatment is carried out on the glass sheet heated and elongated, and then, the metal halide particles are reduced.

Further, according to a method for producing a polarizing glass of the invention, the annealing treatment is carried out at a temperature equal to or less than a temperature during heating and elongating glass.

Further, according to a method for producing a polarizing glass of the invention, the annealing treatment is carried out at a temperature equal to or less than a annealing point of the glass.

Further, according to a method for producing a polarizing glass of the invention, wherein the annealing treatment is carried out at a temperature equal to or less than a annealing point of the glass.

Further, according to a method for producing a polarizing glass of the invention, the annealing treatment is carried out at a temperature equal to or less than a melting point of the metal halide particle.

Further, according to a method for producing a polarizing glass of the invention, the heating and elongating is carried out after an etching treatment of the glass preform is performed.

Further, according to a method for producing a polarizing glass of the invention, the heating and elongating is carried out after an etching treatment of the glass preform is performed.

Further, according to a method for producing a polarizing glass of the invention, the etching treatment is a treatment of chamfering sharp edges of the glass preform into a shape of a circular arc by dissolving the sharp corner with an etching solution.

Further, according to a method for producing a polarizing glass of the invention, the etching treatment is a treatment of chamfering sharp edges of the glass preform into a shape of a circular arc by dissolving the sharp corner with an etching solution.

Further, according to a method for producing a polarizing glass of the invention, the heating and elongating is carried out after a polishing treatment of the glass preform is performed.

Further, according to a method for producing a polarizing glass of the invention, the heating and elongating is carried out after a polishing treatment of the glass preform is performed.

Further, according to a method for producing a polarizing glass of the invention, the heating and elongating is carried out after a polishing treatment of the glass preform is performed.

Further, according to a method for producing a polarizing glass of the invention, the heating and elongating is carried out after a polishing treatment of the glass preform is performed.

Further, according to a method for producing a polarizing glass of the invention, the heating and elongating is carried out after a polishing treatment of the glass preform is performed.

Further, according to a method for producing a polarizing glass of the invention, the heating and elongating is carried out after a polishing treatment of the glass preform is performed.

By annealing the glass sheet after cooling the glass sheet at a temperature below a predetermined temperature, e.g., below melting point of particles of the halide metallic materials (below the temperature at which each particle of the halide metallic material does not reform back to a spherical shape), strain, which is generated during heating and elongating processes and residues in a glass sheet, is eliminated without causing decrease of the extinction ratio.

Therefore, according to the present invention, a polarizing glass of good optical characteristics may be provided at a low cost.

### DETAILED DESCRIPTION OF THE INVENTION

An embodiment of the present invention will be described hereinafter.

A polarizing glass of the present embodiment may be manufactured by a well-known method for producing a polarizing glass (hereinafter, referred to the “conventional method”).

According to the conventional method, a base glass material is manufactured by melting halide metallic materials such as silver, copper, or copper-cadmium together with raw material of glass composed of SiO₂, B₂O₃, Al₂O₃, etc. Then, a glass preform in which metal halide particles having a prescribed particle size are precipitated is manufactured by conducting a heat treatment on the base glass material. Then, the glass preform is heated and stressed and thus metal halide particles are elongated. By conducting a heating-reducing process in a hydrogen atmosphere, the elongated metal halide particles have aspect ratio suited to the applied wavelength range.

The present embodiment may be performed by adding a prescribed annealing process to the conventional method without substantially changing the conventional method.

Further, the annealing is an operation of heating and cooling suited to solid materials returning to a standard state by removing the influence of heat hysteresis and working hysteresis remaining in the internal structure of the solid material as much as possible. In the present embodiment, the annealing is a low-temperature annealing which removes a part of the residue stress and makes a return to the standard state.

The followings are the details thereof.

According to the present embodiment, the glass materials and the halide metallic materials are melted and mixed, and then, solidified to form a base glass material. By conducting a heat treatment of the base glass material, a glass preform in which metal halide particles of a prescribed particle size are dispersed is formed. Then, by heating and elongating the glass preform at a prescribed temperature, a glass sheet containing elongated metal halide particles is formed. After that, by reducing the metal halide particles to make them metal, a polarizing glass having a prescribed polarization characteristic is manufactured. The method for producing a polarizing glass may conduct an annealing process on the heated and elongated glass sheet and then reduce the metal halide particles.

Glass containing metal halide particles is adopted as the base glass material.

The metal halide particles are precipitated by melting the base glass material (a transition point temperature and a softening point temperature of glass are substantially 520° C. and 690° C., respectively) and heating the glass preform which is cut out from the base glass material in a board shape or a block shape.

Specifically, by conducting the heat treatment on the glass preform, metal halide particles which are 60 nm to 80 nm in diameter are precipitated. It is perceived that the precipitated metal halide particles are AgCl, AgBr, or mixed crystal of AgClBr, in case the metal is silver. Here, melting points of AgCl and AgBr are substantially 450° C. and 435° C., respectively.

Although an existing state of the metal halide particles is not made clear yet, it is perceived that metal ions and halogen ions separately exist in the glass preform and, if light or heat energy is applied, they constitute metal halide particles.

An aspect ratio which affects characteristics of the polarizing glass is a ratio of a major diameter and a minor diameter of the metal halide particle elongated in the elongating process or the elongated metal halide particle after the reducing process. Therefore, it is preferable that a group of the precipitated metal halide particles is of uniform size in order to stabilize the characteristics of the polarizing glass. Thus, the temperature of the base glass during the heat treatment is important and is controlled to a uniform temperature on the surface of and inside of the base glass so that the precipitated particles have a uniform size.

A method of control is to conduct stirring by providing a fan in an electric furnace, to optimize time of temperature rising, treatment, and temperature lowering, or to learn a method for disposing the base glass. A standard deviation of distribution of the diameters of a group of the metal halide particles acquired by the above procedures is less than 10 nm.

The elongation of the glass is carried out by sending the preform in which the metal halide particles are precipitated into the inside of the electric furnace at a fixed speed, heating the glass preform to a temperature at which viscosity of the glass preform becomes a prescribed value, specifically, 1×10⁷ poises to 1×10⁸ poises, and applying a tensile stress of 100 Kg/cm² to 600 Kg/cm² on the glass perform by using a pulling apparatus provided in the lower part of the electric furnace. The applied stress may be controlled by a sending speed and a pulling speed of the glass preform in addition to the viscosity of the glass.

The applied stress is set to a value capable of acquiring a target aspect ratio within a range where the glass preform is not broken. A metal halide particle having a small diameter of substantially 20 nm is difficult to be elongated unless the stress is high. Further, a metal halide particle having a large diameter of substantially 100 nm is easily elongated even with a small stress. Therefore, if a glass preform in which metal halide particles of different particle sizes are distributed is elongated with uniform stress, it is possible to manufacture a glass preform containing a group of elongated metal halide particles having different aspect ratios according to the size of the diameter.

Specifically, according to the present embodiment, the glass sheet is acquired by heating a glass preform to a temperature range from 650° C. to 700° C. at which viscosity of glass becomes 1×10⁸ poises and elongating the glass preform. At this time, the glass sheet drawn from the heating furnace is cooled naturally at a room temperature.

Then, the annealing process is carried out at a temperature equal to or less than a prescribed temperature of heating and elongating the glass. Specifically, a slow cooling point temperature is a temperature at which residual strain of the glass is substantially relieved in a few minutes and a strain point temperature is a temperature under which strain is not generated. Since the strain point temperature is less than the slow cooling point by substantially 30° C. to 100° C., it is preferable that the annealing process is carried out at a temperature equal to or less than the slow cooling point temperature of the glass. Especially, it is preferable to conduct the annealing process at a temperature equal to or less than the melting point of the metal halide particles because it can certainly prevent the metal halide particle from melting and from restoring to a spherical shape.

Further, it is possible to more certainly prevent the glass preform (glass sheet) from being cracked due to the heating and elongating by heating and elongating the glass preform after conducting an etching treatment and a polishing process for dissolving a sharp corner of the glass preform with an etching solution to chamfer the edges into a shape of a circular arc.

In order to give a polarization characteristic to the elongated glass preform, it is required to reduce at least a part of the elongated metal halide particles in the glass and to make them elongated metallic particles.

The reduction is generally conducted by exposing the glass to heat in a hydrogen atmosphere. A reducing reaction is dependent on atmosphere temperature and reduction time. Especially, the atmosphere temperature is important. Although the reducing process time is shorten if the atmosphere temperature is high, the elongated metal halide particles restore spherical shape and the extinction ratio is deteriorated which generates lowering of the aspect ratio. Although the elongated metal halide particles do not restore spherical shape if the atmosphere temperature is low, it takes time to perform the reducing treatment and thus the cost increases. Further, according to the atmosphere temperature, the width of distribution of the aspect ratio becomes narrower, and as a result, a band also becomes narrower due to the lowering of aspect ratio of a part of the elongated metal halide particles. Thus, it is preferable to conduct reduction at a temperature equal to or higher than 400° C., more preferably, within a range of 410° C. to 470° C., during one (1) to 12 hours.

A reducing furnace used for reduction is operated with a hydrogen flow under atmospheric pressure. Further, since the hydrogen used in the reducing treatment is burned by using a torch after coming out of a sample chamber of the reducing furnace, there is not a danger such as explosion and safety is high.

According to the above embodiment, it is possible to provide a polarizing glass of good optical characteristics and low cost.

Further, it is preferable to conduct the heating and elongating treatment and the annealing treatment consecutively by providing an annealing furnace near the heating furnace, putting a glass sheet into the annealing furnace immediately after heating and elongating the glass preform to make the glass sheet, lowering the temperature of the glass sheet to a temperature equal to or less than a prescribed temperature during heating and elongating of the glass sheet, and maintaining the temperature less than the prescribed temperature during heating and elongating for a prescribed time. In this case, it is possible to conduct the heating and elongating treatment and the annealing treatment in line and to manufacture the polarizing glass very efficiently.

In the following, it is described on test examples making effects of the present embodiment clear.

### TEST EXAMPLE 1

After putting a glass sheet which is not cracked yet into the annealing furnace immediately after the elongating and maintaining 500° C. for a prescribed time, the glass sheet is cooled to a room temperature in the annealing furnace. After annealing, no crack is found in the glass sheet. Further, although the glass sheet is polished, no crack is found. Then, after the reducing treatment is performed on the annealed glass sheet with hydrogen, an extinction ratio is measured and the value is 25 dB. Since a polarizing glass is required to have extinction ratio equal to or higher than 40 dB, the value is low.

### TEST EXAMPLE 2

After putting a glass sheet which is not cracked yet into the annealing furnace immediately after the elongating and maintaining 460° C. for a prescribed time, the glass sheet is cooled to a room temperature in the annealing furnace. After annealing, no crack is found in the glass sheet. Further, although the glass sheet is polished, no crack is found. Then, after the reducing treatment is performed on the annealed glass sheet with hydrogen, an extinction ratio is measured and the value is equal to or less than 40 dB.

### TEST EXAMPLE 3

After putting a glass sheet which is not cracked yet into the annealing furnace immediately after the elongating and maintaining 400° C. for a prescribed time, the glass sheet is cooled to a room temperature in the annealing furnace. After annealing, crack is found in substantially ten percent (10%) of the glass sheets. Further, if the glass sheets are polished, crack is found in substantially three percent (3%). Then, after the reducing treatment is performed on the annealed glass sheet with hydrogen, an extinction ratio is measured and the value is equal to or higher than 60 dB.

### TEST EXAMPLE 4

After putting a glass sheet which is not cracked yet into the annealing furnace immediately after the elongating and maintaining 420° C. for a prescribed time, the glass sheet is cooled to a room temperature in the annealing furnace. After annealing, no crack is found in the glass sheet. Further, although the glass sheet is polished, no crack is found. Then, after the reducing treatment is performed on the annealed glass sheet with hydrogen, an extinction ratio is measured and the value is equal to or higher than 50 dB.

### TEST EXAMPLE 5

After putting a glass sheet which is not cracked yet into the annealing furnace immediately after the elongating and maintaining 440° C. for a prescribed time, the glass sheet is cooled to a room temperature in the annealing furnace. After annealing, no crack is found in the glass sheet. Further, although the glass sheet is polished, no crack is found. Then, after the reducing treatment is performed on the annealed glass sheet with hydrogen, an extinction ratio is measured and the value is equal to or higher than 50 dB.

### TEST EXAMPLE 6

The annealing furnace is provided in the lower part of the heating furnace for elongating a glass preform and the elongated glass preform is annealed consecutively. At this time, the temperature of the annealing furnace is set to 420° C. Further, a speed at which the glass sheet passes through the annealing furnace is equal to or less than 20 cm/min. No crack is found in the glass sheet coming out of the annealing furnace. However, if the glass sheet is left as it is at a room temperature for several hours, crack is found in substantially seven percent (7%) of the glass sheets. Further, although the other glass sheets are polished, no crack is found. Then, after the reducing treatment is performed on the annealed glass sheet with hydrogen, an extinction ratio is measured and the value is equal to or higher than 50 dB.

### TEST EXAMPLE 7

The annealing furnace is provided in the lower part of the heating furnace for elongating a glass preform and the elongated glass preform is annealed consecutively. At this time, the temperature of the annealing furnace is set to 500° C. Further, a speed at which the glass sheet passes through the annealing furnace is equal to or less than 20 cm/min. No crack is found in the glass sheet coming out of the annealing furnace. However, if the glass sheet is left as it is at a room temperature for several hours, crack is found in substantially two percent (2%) of the glass sheets. Further, although the other glass sheets are polished, no crack is found. Then, after the reducing treatment is performed on the annealed glass sheet with hydrogen, an extinction ratio is measured and the value is equal to or higher than 50 dB.

According to the above test examples, although the strain of glass can be removed by lowering temperature slowly from the slow cooling point temperature to the strain point temperature, the slow cooling temperature and the strain point temperature of the polarizing glass are higher than the melting point of the metal halide particle. Thus, if the annealing is carried out near the slow cooling temperature and the strain point temperature, it is found that the metal halide particles are restored to a spherical shape and lowering of the extinction ratio is caused. Further, it is found that the polarizing glass has good optical characteristics by conducting the annealing treatment of the polarizing glass at a temperature less than the melting point of the metal halide particle.

Further, in case of conducting the annealing treatment of the glass sheet consecutively after heating and elongating the glass preform, it is found preferable for the annealing treatment temperature to be equal to or less than the slow cooling point temperature, while the annealing is performed insufficiently and thus crack is found in a part of the glass sheets because a staying period in the annealing furnace is limited.

What is claimed is:

1. A method for producing a polarizing glass having a prescribed polarization characteristic by heating to a prescribed temperature and elongating a glass preform in which metal halide particles of prescribed particle sizes are dispersed to form a glass sheet containing the elongated metal halide particles and then reducing the metal halide particles to make metal, wherein an annealing treatment is carried out on the glass sheet heated and elongated, and then, the metal halide particles are reduced.

2. A method for producing a polarizing glass as claimed in claim 1, wherein said annealing treatment is carried out at a temperature equal to or less than an elongating temperature of the glass preform.

3. A method for producing a polarizing glass as claimed in claim 1, wherein said annealing treatment is carried out at a temperature equal to or less than an annealing point of the.

4. A method for producing a polarizing glass as claimed in claim 2, wherein said annealing treatment is carried out at a temperature equal to or less than a annealing point of the glass.

5. A method for producing a polarizing glass as claimed in claim 1, wherein said annealing treatment is carried out at a temperature equal to or less than a melting point of the metal halide particle.

6. A method for producing a polarizing glass as claimed in claim 1, wherein said heating and elongating step is carried out after an etching treatment of the glass preform is performed.

7. A method for producing a polarizing glass as claimed in claim 5, wherein said heating and elongating step is carried out after an etching treatment of the glass preform is performed.

8. A method for producing a polarizing glass as claimed in claim 6, wherein said etching treatment is a treatment of chamfering a sharp corner of the glass preform into a shape of a circular arc by dissolving the sharp corner with an etching solution.

9. A method for producing a polarizing glass as claimed in claim 7, wherein said etching treatment is a treatment of chamfering a sharp corner of the glass preform into a shape of a circular arc by dissolving the sharp corner with an etching solution.

10. A method for producing a polarizing glass as claimed in claim 1, wherein said heating and elongating step is carried out after a polishing treatment of the glass preform is performed.

11. A method for producing a polarizing glass as claimed in claim 5, wherein said heating and elongating is carried out after a polishing treatment of the glass preform is performed.

12. A method for producing a polarizing glass as claimed in claim 6, wherein said heating and elongating is carried out after a polishing treatment of the glass preform is performed.

13. A method for producing a polarizing glass as claimed in claim 7, wherein said heating and elongating is carried out after a polishing treatment of the glass preform is performed.

14. A method for producing a polarizing glass as claimed in claim 8, wherein said heating and elongating is carried out after a polishing treatment of the glass preform is performed.

15. A method for producing a polarizing glass as claimed in claim 9, wherein said heating and elongating is carried out after a polishing treatment of the glass preform is performed.
